(19) United States
(12) Patent Application Publication
(10) Pub. No.: US 2019/0155078 A1
(43) Pub. Date: May 23, 2019

(54) PROCESS OF PRODUCING A LIQUID CRYSTAL DISPLAY AND A CURABLE RESIN COMPOSITION USED IN THE SAME

(71) Applicant: HENKEL AG & CO. KGAA, Duesseldorf (DE)

(72) Inventors: Qin LI, Shanghai (CN); Jing LU, Shanghai (CN); Minghai WANG, Shanghai (CN); Dawei CHEN, Shanghai (CN)

(21) Appl. No.: 16/242,077

(22) Filed: Jan. 8, 2019

Related U.S. Application Data
(63) Continuation of application No. PCT/CN2016/089408, filed on Jul. 8, 2016.

(51) Int. Cl. G02F 1/1339; G02F 1/1341

(52) U.S. Cl. CPC G02F 1/1339; G02F 2001/13415; G02F 2202/025; G02F 1/1341

(57) ABSTRACT

The present invention relates to an improved one-drop-filling process of producing a liquid crystal display having a liquid crystal layer between a first substrate and a second substrate, comprising steps of applying a curable resin composition on a sealing region at a periphery of a surface of the first substrate; radiation curing the curable resin composition, and obtaining a partially cured product; dropping liquid crystal on a central area encircled by the sealing region of the surface of the first substrate or the corresponding area of the second substrate, and forming the liquid crystal layer; overlaying the second substrate on the first substrate; and thermal curing the partially cured product.

### FIELD OF THE INVENTION

This invention relates to a process of producing a liquid crystal display and to a curable resin composition used in the same. In particular, the invention relates to an improved one-drop-filling process of producing a liquid crystal display.

### BACKGROUND OF THE INVENTION

Liquid crystal display (LCD) panels having the characteristics of being light-weight and high-definition have been widely used as display panels for a variety of apparatuses including cell phones and TVs. Conventionally, the process for producing a LCD panel is called a one-drop-filling (ODF) process which, as shown in FIG. 1, comprising applying a sealant on a substrate having an electrode pattern and an alignment film under vacuum condition, dropping liquid crystal (LC) on the substrate having the sealant applied thereon, joining opposite facing substrates to each other under vacuum, then releasing the vacuum and performing ultraviolet (UV) irradiation or UV irradiation plus heating to cure the sealant and thereby producing a LCD cell.

Recently, development of LCD has been more towards the direction of “slim border” or “narrow bezel” design. Among several ways to achieve this goal, one is the use of a narrow width of the sealant. However, a thinner line of sealant creates more challenge with typical ODF process due to the fact that the process needs to meet very high reliability to prevent the liquid crystal material from leakage, misalignment and contamination.

In addition, in normal ODF process, radiation curing, such as UV curing, and thermal curing are used to cure the sealant by single use or combination. UV light can be irradiated from color filter side and array side of the cell. In recent years, picture frames of LCD part have been narrowed down for the downsizing of LCD containing equipment such as mobile phones, mobile game machines. Therefore, patterns of the sealant formed on a substrate is increasingly located at a position overlapping with the black matrix. This may cause a problem as the overlapping portion of sealant on black matrix remains uncured and flowable even after being UV irradiated. The uncured sealant easily elutes from the overlapping portion into liquid crystal which causes LC contamination.

On the other hand, although irradiating UV light from array side is also conceivable, challenges still remain since metal wirings and transistors on the array substrate overlap with the sealant pattern and create shadow area, which may in turn result in “shadow cure” issue as uncured portion of the sealant is apt to elute from sealant and comes into contact with LC which will also cause LC contamination.

Thus, there is still a need for an improved ODF process that can solve above-mentioned challenges. In particular, the present invention provides a modified ODF process in which the sealant is partially cured prior to the coupling of the substrates. As a result, the ODF process according to the present invention may take the advantage of elimination of shadow cure issue, better misalignment of liquid crystal, as well as much less leakage and contamination of liquid crystal, compared to a ODF process currently applied in the art.

### BRIEF DESCRIPTION OF THE FIGURES

FIG. 1 illustrates a flow chart of ODF process according to prior art.

FIG. 2 illustrates a flow chart of ODF process according to present invention.

FIG. 3 illustrates a liquid crystal display component used in the sealing performance evaluation.

FIGS. 4a to 4c show the results of cell inspection in Examples 1 to 3, respectively.

FIGS. 5a to 5c show the results of line shape and line width of cured sealants in Examples 1 to 3, respectively.

### SUMMARY OF THE INVENTION

The present invention provides a process of producing a liquid crystal display having a liquid crystal layer between a first substrate and a second substrate, said process comprising steps of:
1) applying a curable resin composition on a sealing region at a periphery of a surface of the first substrate;
2) radiation curing the curable resin composition, and obtaining a partially cured product;
3) dropping liquid crystal on a central area encircled by the sealing region of the surface of the first substrate or the corresponding area of the second substrate, and forming the liquid crystal layer;
4) overlaying the second substrate on the first substrate; and
5) thermally curing the partially cured product.

The present invention also provides a curable resin composition used for the process of producing a liquid crystal display according to the present invention.

Furthermore, the present invention provides a liquid crystal display manufactured by the process of producing a liquid crystal display according to the present invention.

### DETAILED DESCRIPTION OF THE INVENTION

In the following passages the present invention is described in more detail. Each aspect so described may be combined with any other aspect or aspects unless clearly indicated to the contrary. In particular, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or process steps.

The recitation of numerical end points includes all numbers and fractions subsumed within the respective ranges, as well as the recited end points.

All references cited in the present specification are hereby incorporated by reference in their entirety.

Unless otherwise defined, all terms used in the disclosing the invention, including technical and scientific terms, have the meaning as commonly understood by one of the ordinary skill in the art to which this invention belongs to. By means of further guidance, term definitions are included to better appreciate the teaching of the present invention.

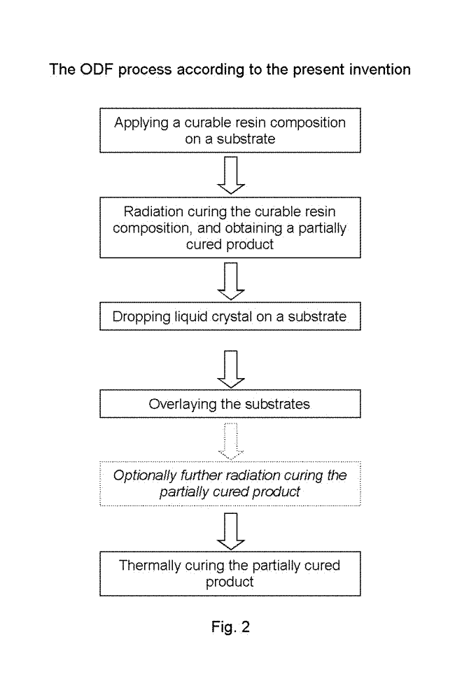

As shown in FIG. 2, the present invention concerns a process of producing a liquid crystal display having a liquid crystal layer between a first substrate and a second substrate, said process comprising steps of:
1) applying a curable resin composition on a sealing region at a periphery of a surface of the first substrate;
2) radiation curing the curable resin composition, and obtaining a partially cured product;
3) dropping liquid crystal on a central area encircled by the sealing region of the surface of the first substrate or the corresponding area of the second substrate, and forming the liquid crystal layer;
4) overlaying the second substrate on the first substrate; and
5) thermally curing the partially cured product.

In the present invention, it has been surprisingly found that the ODF process according to the present invention allows for an improved reliability and quality of the LCD display produced by the process.

Specifically, it is an advantage of the process of producing a LCD to provide a LCD cell assembly without liquid crystal penetration and leakage.

It is another advantage of the process of producing a LCD to improve the liquid crystal alignment of the LCD assembly.

It is yet another advantage of the process of producing a LCD to eliminate the shadow cure issue.

Step 1)

In step 1) of the LCD producing process according to the present invention, the curable resin composition is applied on the periphery portion of the surface of the first substrate so as to lap around the substrate circumference in a frame shape. The portion where the curable resin composition is applied in a frame shape is referred as a sealing region. The curable resin composition can be applied by a known method in the art such as screen printing and dispensing, preferably by dispensing.

The sealing region generally has a rectangular box shape, LCD display portion is formed in the sealing region inside the central zone. The sealing region on the outer surface of the substrate, electrode and the electrical/electronic parts installation space may be used if desired.

The first substrate and the second substrate used in the present invention are usually transparent glass substrates. Generally, transparent electrodes, active matrix elements (such as thin film transistor TFT), alignment film(s), a color filter and the like are formed on at least one of the opposed faces of the two substrates. These constitutions may be modified according to the type of LCD. The manufacturing method according to the present invention may be thought to be applied for any type of LCD.

Curable Resin Composition

The curable resin composition or sealant composition suitable to be used in the present process comprises a radiation curable resin, a thermally curing agent and optionally an epoxy resin.

Specifically, the radiation curable resin used in the present is a (meth)acrylic resin. As used herein, the term “(meth)acrylic resin” refers to an acrylic resin and methacrylic resin both.

Examples of the (meth)acrylic resin includes but not limited to a ester compound obtainable by a reaction of a (meth)acrylic acid with a compound having a hydroxyl group, epoxy (meth)acrylate obtainable by a reaction of a (meth)acrylic acid with an epoxy compound, and urethane (meth)acrylate obtainable by a reaction of an isocyanate with a (meth)acrylic acid derivative having a hydroxyl group, and mixture or combination thereof.

The ester compound obtainable by the reaction of a (meth)acrylic acid with a compound having a hydroxyl group is not particularly limited. Examples of the ester compound with a mono-functional group include but not limited to 2-hydroxyethyl (meth)acrylate, 2-hydroxybutyl (meth)acrylate, isobutyl (meth)acrylate, phenoxy polyethylene glycol (meth)acrylate, imide (meth)acrylate, methyl (meth)acrylate, ethyl (meth)acrylate, n-butyl (meth)acrylate, propyl (meth)acrylate, n-butyl (meth)acrylate, cyclohexyl (meth)acrylate, and 2-ethylhexyl (meth)acrylate. Examples of the ester compound with two functional groups include but not limited to 1,6-hexanediol di(meth)acrylate, and 1,9-nonanediol di(meth)acrylate. Examples of the ester compound with three or more functional groups include pentaerythritol tri(meth)acrylate, and trimethylolpropane tri(meth)acrylate.

The epoxy (meth)acrylate is a derivative of epoxide resin which has one or more (meth)acrylate groups and are substantially free of epoxy groups, obtainable by reaction of a (meth)acrylic acid with an epoxy compound. Examples include but not limited to an epoxy (meth)acrylate obtainable by reaction of an epoxy resin with (meth)acrylic acid in the presence of a basic catalyst according to a known method in the art. Preferably, the epoxy (meth)acrylate is a fully acrylated compound in which almost 100% of the epoxy groups can be converted to acrylic groups.

Examples of the epoxy (meth)acrylate commercially available include but not limited to Ebecryl 3700, Ebecryl 3600, Ebecryl 3701, Ebecryl 3703, Ebecryl 3200, Ebecryl 3201, Ebecryl 3600, Ebecryl 3702, Ebecryl 3412, Ebecryl 860, Ebecryl RDX63182, Ebecryl 6040, Ebecryl 3800 (all manufactured by Daicel UCB Co., Ltd.), EA-1020, EA-1010, EA-5520, EA-5323, EA-CHD, EMA-1020 (all manufactured by Shin-Nakamura Chemical Co., Ltd.).

The urethane (meth)acrylate obtainable by reaction of the isocyanate with a (meth)acrylic acid derivative having a hydroxyl group can be obtained by reacting 1 equivalent amount of a compound having two isocyanate groups with 2 equivalent amount of the (meth)acrylic acid derivative having a hydroxyl group in the presence of a catalyst amount of tin compounds.

Examples of the commercially available urethane (meth)acrylate include M-1100, M-1200, M-1210, M-1600 (all manufactured by Toagosei Co., Ltd.), Ebecryl 230, Ebe-cryl 270, Ebecryl 4858, Ebecryl 8402, Ebecryl 8804, Ebecryl 8803, Ebecryl 8807, Ebecryl 9260, Ebecryl 1290, Ebecryl 5129, Ebecryl 4842, Ebecryl 210, Ebecryl 4827, Ebecryl 6700, Ebecryl 220, Ebecryl 2220 (all manufactured by Daicel UCB Co., Ltd.), Art Resin UN-9000H, Art Resin UN-9000A, Art Resin UN-7100, Art Resin UN-1255, Art Resin UN-330, Art Resin UN-3320HB, Art Resin UN-1200TPK, Art Resin SH-500B (all manufactured by Negami Chemical Industrial Co., Ltd.).

In one embodiment, the curable resin composition is a (meth)acrylic resin, preferably an epoxy (meth)acrylic resin, having one or more, preferably one or two epoxy functional groups.

The radiation curable resin is present from 10% to 98%, preferably from 30% to 95%, by weight of the curable resin or sealant composition.

Epoxy Resin

To further enhance the sealing performance including adhesion strength and reliability, an epoxy resin may be used in the curable resin composition. The epoxy resin component of the present invention may include any common epoxy resin, including but not limited to, aromatic glycidyl ethers, aliphatic glycidyl ethers, aliphatic glycidyl esters, cycloaliphatic glycidyl ethers, cycloaliphatic glycidyl esters, cycloaliphatic epoxy resins, and mixtures thereof.

Preferably, a solid epoxy resin having a melting point of 40° C. or above is used in the present invention. The incorporation of a solid epoxy resin may adjust the viscosity of the curable resin composition according to the present invention and further improve the performance of the sealant, such as higher glass transition temperature, or higher flexibility, or higher adhesion strength, depending on the selected solid epoxy resin.

Moreover, the solid epoxy resin preferably ranges in number average molecular weight of 500 to 3000 g/mol. When the number-average molecular weight is within this range, the solid epoxy resin shows low solubility and diffusibility in the liquid crystal, and permits the obtained liquid crystal display panel to exhibit excellent display characteristics. The number average molecular weight of the epoxy resin can be measured by gel permeation chromatography (GPC) using polystyrene standard.

Specific examples of the solid epoxy resin having a melting point of 40° C. or above include aromatic polyvalent glycidylether compounds obtained by reaction, with epichlorohydrin, of aromatic diols such as bisphenol A, bisphenol S and bisphenol F, or modified diols obtained by modifying the above diols with ethylene glycol, propylene glycol and alkylene glycol; novolak-type polyvalent glycidylether compounds obtained by reaction, with epichlorohydrin, of novolak resins derived from phenols or cresols and formaldehydes, or polyphenols such as polyalkenylphenols and copolymers thereof; and glycidylether compounds of xylylene phenolic resins.

More preferably, cresol novolak epoxy resin, phenol novolak epoxy resin, bisphenol A epoxy resin, bisphenol F epoxy resin, triphenolmethane epoxy resin, tripheolethane epoxy resin, trisphenol epoxy resin, dicyclopentadiene epoxy resin and biphenyl epoxy resin may be used in the present invention, provided that the melting point is 40° C. or above.

Suitable commercially available epoxy resin to be used in the present invention are for example JER YL 980, a bisphenol A type epoxy resin, manufactured by Mitsubishi Chemical Corporation.

If present, the epoxy resin is contained in the composition from 1% to 60%, preferably from 10% to 50% by weight of the curable resin composition.

Thermally Curing Agent

The curable resin composition further contains a thermally curing agent to ensure a final thermal curing in step 5) of the ODF process according to the present invention. Usually a latent curing agent or a thermal free radical polymerization initiator can be used as the catalyst. A latent curing agent is preferably used in the curable resin composition as thermally curing agent.

A latent curing agent is based on a latent hardener that will be liberated at a certain temperature. The latent curing agent can be obtained easily from the commercially available latent epoxy curing agent and used alone or in a combination of two or more kinds. Specifically, the latent epoxy curing agent to be preferably used includes amine-based compounds, fine-powder-type modified amine and modified imidazole based compounds. Examples of the amine-based latent curing agent include dicyandiamide, hydrazides such as adipic acid dihydrazide, oxalic acid dihydrazide, malonic acid dihydrazide, succinic acid dihydrazide, glutaric acid dihydrazide, suberic acid dihydrazide, azelaic acid dihydrazide, sebacic acid dihydrazide, and phthalic acid dihydrazide. The modified amine and modified imidazole based compounds include core-shell type in which the surface of an amine compound (or amine adducts) core is coated with the shell of a modified amine product (surface adduction and the like) and master-batch type hardeners as a blend of the core-shell type curing agent with an epoxy resin.

Examples of commercially available latent curing agents include, but not limited to: Adeka Hardener EH-5011S (imidazole type), Adeka Hardener EH-4357S (modified amine type), Adeka Hardener EH-4357PK (modified amine type), Adeka Hardener EH-4380S (special hybrid type), Adeka Hardener EH-5001P (special modified type), Ancamine 2014FG/2014AS (modified polyamine), Ancamine 2441(modified polyamine), Ancamine 2337s (modified amine type), Fujicure FXR-1081(modified amine type), Fujicure FXR-1020 (modified amine type), Sunmide LH-210 (modified imidazole type), Sunmide LH-2102 (modified imidazole type), Sunmide LH-2100 (modified imidazole type), Ajicure PN-23 (modified imidazole type), Ajicure PN-23J (modified imidazole type), Ajicure PN-31 (modified imidazole type), Ajicure PN-31J (modified imidazole type), Novacure HX-3722 (master batch type), Novacure HX-3742 (master batch type), Novacure HX-3613 (master batch type), and mixture thereof.

In one preferred embodiment, latent curing agents having a melting temperature of 50 to 150° C., particularly having a melting temperature of 60 to 120° C. are suitable to be used in the curable resin composition in the present invention. Those having a melting temperature lower than 50° C. have the problem of poor viscosity stability, while those having a melting temperature higher than 150° C. need longer time of thermal curing, which causes a higher tendency of liquid crystal contamination.

Thermal free radical initiators are those can decompose and release free radicals when thermally activated, thereby initiate the crosslinking reaction of acrylate resin with other components if present in heating process of step 5) to achieve a full curing of the sealant composition.

Suitable thermal free radical initiators include, for example, organic peroxides and azo compounds that are known in the art. Examples include: azo free radical initiators such as AIBN (azodiisobutyronitrile), 2,2′-azobis(4-methoxy-2,4-dimethyl valeronitrile), 2,2′-azobis(2,4-dimethyl valeronitrile), dimethyl 2,2′-azobis(2-ethylpropionate), 2,2′-azobis(2-methylbutyronitrile), 1,11-azobis(cyclohexane-1-carbonitrile), 2 ,2′-azobis[N-(2-propenyl)-2-methylpropionamide]; dialkyl peroxide free radical initiators such as 1,1-di-(butylperoxy-3,3,5-trimethyl cyclohexane); alkyl per-ester free radical initiators such as TBPEH (t-butyl per-2-ethylhexanoate); diacyl peroxide free radical initiators such as benzoyl peroxide; peroxy dicarbonate radical initiators such as ethyl hexyl percarbonate; ketone peroxide initiators such as methyl ethyl ketone peroxide, bis(t-butyl peroxide) diisopropylbenzene, t-butylperbenzoate, t-butyl peroxy neodecanoate, and mixture thereof.

Further examples of organic peroxide free radical initiators include: dilauroyl peroxide, 2,2-d i(4,4-di(tert-butylperoxy)cyclohexyl)propane, di(tert-butylperoxyisopropyl) benzene, di(4-tert-butylcyclohexyl) peroxydicarbonate, dicetyl peroxydicarbonate, dimyristyl peroxydicarbonate, 2,3-dimethyl-2,3-diphenylbutane, dicumyl peroxide, dibenzoyl peroxide, diisopropyl peroxydicarbonate, tert-butyl monoperoxymaleate, 2,5-dimethyl-2,5-di(tert-butylperoxy)hexane, tert-butylperoxy 2-ethylhexyl carbonate, tert-amyl peroxy-2-ethylhexanoate, tert-amyl peroxypivalate, tert-amylperoxy 2-ethylhexyl carbonate, 2,5-dimethyl-2,5-di(2-ethylhexanoylperoxy) hexane 2,5-dimethyl-2,5-di(tert-butylperoxy)hexpe-3, di(3-methoxybutyl)peroxydicarbonate, diisobutyryl peroxide, tert-butyl peroxy-2-ethylhexanoate (trigonox 21 S), 1,1 -di(tert-butylperoxy)cyclohexane, tert-butyl peroxyneodecanoate, tert-butyl peroxy-pivalate, tert-butyl peroxyneoheptanoate, tert-butyl peroxydiethylacetate, 1,1-di(tert-butylperoxy)-3,3,5-trimethylcyclohexane, 3,6,9-triethyl-3,6,9-trimethyl-1,4,7-triperoxonane, di(3,5,5-trimethylhexanoyl) peroxide, tert-butyl peroxy-3,5,5-trimethyl hexanoate, 1,1,3,3-tetramethylbutyl peroxy-2-ethylhexanoate, 1,1,3,3-tetramethyl-butyl peroxyneodecanoate, tert-butyl peroxy-3,5,5-trimethyl hexanoate, cumyl per-oxyneodecanoate, di-tert-butyl peroxide, tert-butylperoxy isopropyl carbonate, tert-butyl peroxybenzoate, di(2-ethylhexyl) peroxydicarbonate, tert-butyl peroxyacetate, isopropylcumyl hydroperoxide, tert-butyl cumyl peroxide, and mixture thereof.

Normally the thermal free radical initiator with higher decomposition rate is preferred, as this can generate free radicals more easily at common curing temperature (80 to 130° C.) and give faster curing speed, which can reduce the contact time between cur-able composition and LC, and reduce the LC contamination. On the other hand, if the decomposition rate of initiator is too high, the viscosity stability at room temperature will be influenced and thereby reducing the work life of the sealant.

To balance the reactivity and viscosity stability of the composition, the thermally curing agent is present from 0.1% to 40%, preferably from 0.5% to 30%, by weight of the curable resin composition.

Additional Components

The curable resin composition may further comprise additional components to improve or modify properties such as flowability, dispensing or printing property, storage property, curing property and physical or mechanical property after being curing.

The additive that may be contained in the composition as needed includes but not limited to organic or inorganic filler, thixotropic agent, silane coupling agent, diluent, modifier, coloring agent such as pigment and dye, surfactant, preservative, stabilizer, plasticizer, lubricant, defoamer, leveling agent and the like. In one embodiment, the composition preferably comprises an additive selected from the group consisting of inorganic or organic filler, thixotropic agent, silane coupling agent, and mixture or combination thereof.

The filler may include, but not limited to, inorganic filler such as silica, diatomaceous earth, alumina, zinc oxide, iron oxide, magnesium oxide, tin oxide, titanium oxide, magnesium hydroxide, aluminium hydroxide, magnesium carbonate, barium sulphate, gypsum, calcium silicate, talc, glass bead, sericite activated white earth, bentonite, aluminum nitride, silicon nitride, and the like; meanwhile, organic filler such as poly(methyl methacrylate), poly(ethyl methacrylate), poly(propyl methacrylate), poly(butyl methacrylate), butylacrylate-methacrylic acid-methyl methacrylate copolymer, poly(acrylonitrile), polystyrene, polybutadiene, polypentadiene, polyisoprene, polyisopropylene, and the like. These can be used alone or in combination thereof.

The thixotropic agent includes, but not limited to, talc, fume silica, superfine surface-treated calcium carbonate, fine particle alumina, plate-like alumina; layered compound such as montmorillonite, spicular compound such as aluminium borate whisker, and the like. Among them, talc, fume silica and fine alumina are preferred.

The silane coupling agent includes, but not limited to, γ-aminopropyltriethoxysilane, γ-mercaptopropyltrimethoxysilane, γ-methacryloxypropyltrimethoxysilane, γ-glycidoxypropyltrimethoxylsilane, and the like. Commercially available examples are SH6062, SZ6030 (produced by Toray-Dow Corning Silicone Inc.), KBE903 and KBM803 (produced by Shin-Etsu Silicon Inc.).

Step 2)

In step 2), the curable resin composition applied on the first substrate was exposed to an actinic radiation so as to temporarily cure the composition and obtain a partially cured product.

Although other type actinic radiation may be utilized, it is preferable to cure the curable resin composition using ultraviolet, visible light or black light radiation. In one preferred embodiment, an ultraviolet radiation having a wavelength of about 200 to about 450 nm, preferably about 300 to about 450 nm is used to cure the composition. In another preferred embodiment, the ultraviolet radiation applied to the composition has radiation energy of about 100 mJ/cm² to about 10,000 mJ/cm², preferably about 500 mJ/cm² to about 5,000 mJ/cm². It is preferable for the radiation source to be substantially perpendicular to the substrate during curing.

UV-A-emitting radiation sources (e.g. fluorescent tubes, LED technology or lamps, which are sold for example by Panacol-Elosol GmbH, Steinbach, Germany, under the name UV-H 254, Quick-Start UV 1200, UV-F 450, UV-P 250C, UV-P 280/6 or UV-F 900), high- or medium-pressure mercury vapour lamps, wherein the mercury vapour can be modified by doping with other elements such as gallium or iron, pulsed lamps (known as UV flash lamps) or halogen lamps, for example, are suitable as radiation sources for UV light in the specified wavelength range in step 2). Further suitable UV emitters or lamps are also can be used in the present invention. The emitters can be installed in a fixed location, such that the item to be irradiated is moved past the radiation source by means of a mechanical device, or the emitters can be mobile and the item to be irradiated does not change its position during the temporary curing in step 2).

High- or medium-pressure mercury vapour lamps are preferably used in the method according to the invention in step 2), wherein the mercury vapour can be modified by doping with other elements such as gallium or iron.

Generally, the radiation time is preferably short, for example no longer than 5 minutes, preferably no longer than 3 minutes, more preferably no longer than 1 minute.

By temporary curing in step 2) of the process, the partially curing product has a modulus as measured at 25° C. from 100 to 100,000 Pa, preferably from 500 to 50,000 Pa, more preferably from 1,000 to 20,000 Pa. The modulus of the partially curing product at 25° C. was measured by photo rheometer (Anton Paar, MCR302) with 100 mW/cm² UVA radiation. The modulus is recorded as the modulus of partially curing product when the UV radiation energy reaches the targeted value.

If the modulus is too high, the partially cured product may not be compressed to achieve an excellent bonding and sealing of the two substrate. If the modulus is too low, the assembly temporarily sealed may not be firm enough, and thus may cause misalignment and even the penetration and leakage of the liquid crystal during the operation of subsequent steps of the process.

Step 3)

In step 3), the liquid crystal is then dropped onto the center area encircled by the sealing region in the frame shape on the surface of the first substrate or the corresponding area on the second substrate. “Corresponding area” means the area of the second substrate corresponding to the center area surrounded by the sealing region of the first substrate when the substrates are attached. Preferably, the liquid crystal is then dropped onto the center area encircled by the sealing region on the first substrate.

Due to the improved process sequence of the present invention, the curable resin composition is actinically cured to obtain a partially cured product before the attachment of the two substrates. It is practical for the inventive process to easily overcome the shadow cure issue which commonly appears in conventional ODF process.

In step 4), a second substrate was superposed or overlaid on the first substrate so that the two substrates can be temporarily fixed by the partially cured product there between.

In step 5), the thermally curing preferably by heating is applied to the partially cured resin product so as to achieve the final curing strength of the sealant, whereby the two substrates are finally fixed. The thermal curing in the step 5) is generally heated at a curing temperature of from 70 to 150° C., preferably at temperature of from 100 to 130° C., with the duration of from 0.5 hour to 3 hours, preferably from 1 hour to 2 hours, and typically 1 hour.

Optionally, the process may further comprise a step of further radiation curing the partially cured product between steps 4) and 5) in case the final curing strength of the fully cured sealant is not satisfactory due to the profiles of the curable resin composition. Preferably, the ODF process according to the present invention does not comprise the step of further radiation curing.

By the aforementioned process, the major part of the LCD panel is manufactured.

In another aspect, the present invention also concerns the curable resin composition used for said process of producing a liquid crystal display according to the present invention.

In yet another aspect, the present invention concerns liquid crystal display manufactured by said process of producing a liquid crystal display according to the present invention.

The producing process and the curable resin composition used in the present invention may be also used for other applications than the liquid crystal one-drop-filling process, where precise assembling without displacement is necessary.

The curable resin composition according to the present invention can be cured into a product with good curability in light-shielded area, excellent adhesion strength and high reliability, which particularly address the light-shielded area curability and reliability requirement such as penetration resistance for the one-drop-filling liquid crystal display assembly process.

### EXAMPLES

The following examples are intended to assist one skilled in the art to better understand and practice the present invention. The scope of the invention is not limited by the examples but is defined in the appended claims. All parts and percentages are based on weight unless otherwise stated.

TABLE 1
(the units of values are represented by weight percentage)

| | | Example | | |
|---|---|---|---|---|
| Component | Trade name | 1 | 2 | 3 |
| Radiation curable | Ebecryl 3700¹ | 76.47 | — | 46.67 |
| resin | Isobornyl | 14.70 | — | — |
| | acrylate² | | | |
| | Uvacure 1561³ | — | 79.36 | — |
| Epoxy resin | YL980⁴ | — | — | 33.33 |
| Latent curing | EN-4357S⁵ | 8.83 | 20.64 | 20 |
| agent | | | | |

¹Ebecryl 3700, a diacrylate ester of a bisphenol A epoxy resin, manufactured by Allnex.
²Isobornyl acrylate, manufactured by Allnex.
³Uvacure 1561, a bisphenol A epoxy acrylate resin, manufactured by Allnex.
⁴JER YL 980, a bisphenol A type epoxy resin, manufactured by Mitsubishi Chemical Corporation.
⁵EH-43578, a modified amine, manufactured by ADEKA Corporation, further grounded to fine powder before using.

The materials listed in the Table 1 were sufficiently mixed by a stirrer and then a three roll miller to give a well distributed curable resin compositions. The Examples were tested by using below described testing process.

Testing Method

Liquid Crystal Sealing Performance Evaluation

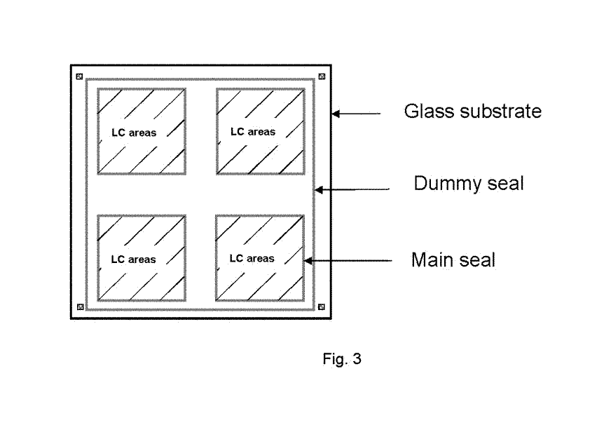

1 part by weight of 3.5 μm spacer was added to 100 parts by weight of each curable resin composition. Then the curable resin composition was filled in a syringe and then dispensed by using a MLC6200 dispenser (manufactured by Musashi) on one of the substrates. The sealant was dispensed in four square shapes (50 mm×50 mm) surrounded by one closed big square which is called “dummy seal”. The dispensing speed was 100 mm/s, and diameter of nozzle was 0.15 mm to achieve the wet area of sealant was 2000 μm², or the dispensing speed was set to 80 mm/s and 0.2 mm nozzle diameter to achieve the wet area of sealant was around 3500 μm², FIG. 3 illustrates the dispensing pattern. Afterwards, the applied curable resin composition was exposed to proper UV radiation according to Table 3 by a UV chamber with mercury lamp (UVX-05016S1CW01, manufactured by USHIO) and temporarily cured consequently. Later a certain grams of liquid crystal (105% liquid crystal quantity calculated in term of the sealing volume) was dropped on the central area encircled by the sealing region, followed by cell assembly process. For cell assembly process, firstly two substrates were placed into the vacuum assembly machine, then degassed in vacuum and the top substrate was overlaid on the bottom substrate. After the attachment of two glass substrates, the vacuum was released to obtain the targeted gap of 3.5 μm. When the cell assembly process was completed, the attached substrates was placed at 25° C. for a so called open time of 2 min and 4 min, respectively, then was put into an oven pre-set at 120° C. for 60 minutes, so as to complete a mimic LCD cell with the ODF process.

The obtained mimic LCD cell was inspected under a microscope to verify the sealing performance, such as the sealing shape maintenance, liquid crystal penetration and liquid crystal compatibility performance.

The penetration performance would be recorded as “good” if the sealing shape was well kept and no liquid crystal penetration was observed; recorded as “fair” if no liquid crystal leakage but some liquid crystal penetration were observed; and recorded as “poor” if no liquid crystal leakage was observed.

The LC compatibility performance would be recorded as “good” if no misalignment was observed; recorded as “fair” if less than 500 μm LC misalignment area was observed; and recorded as “poor” if more than 500 μm LC misalignment area was observed or LC misalignment cannot be inspected due to the failure of making a cell.

The quality of cell assembly by the present ODF process would be recorded as “good” if a cell with no LC leakage, no gap issue and proper line width was obtained; and recorded as “poor” if either LC leakage or improper cell gap was observed.

Example 1 of sealant composition was used to produce cells through different ODF processes including the inventive process, normal UV plus thermal curing process according to prior art and pure thermal curing process. LC penetration and LC compatibility were inspected under a microscope with a magnification of X100.

TABLE 2
The test results by different processes

| | | Process | | |
|---|---|---|---|---|
| | Open | | Prior | Pure |
| Items | time | Inventive | art¹ | thermal² |
| Penetration | 2 min | Good | Fair | Poor |
| Penetration | 4 min | Good | Poor | Poor |
| Compatibility | 2 min | Good | Good | Poor |

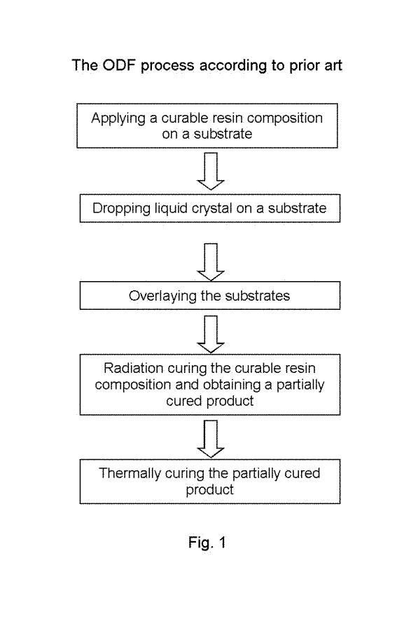

¹“Prior art” process means the normal ODF process according to FIG. 1.
²“Pure thermal” process means the same process as the normal ODF process except that the step of radiation curing the curable resin composition was not included.

As an important requirement to ensure the quality and reliability of LCD panel, LC or air penetration is very critical, especially when the line width of sealant becomes narrower and narrower which obviously is the market trend or when the cell gap is high. Penetration from LC or air may lead to low adhesion and poor water barrier which may cause failure in reliability test. Furthermore, severe LC penetration may cause LC leakage during cell assembly.

As shown from the testing results of Table 2, the samples manufactured by the inventive process with the sealant of Example 1 showed much better LC penetration resistance than those manufactured by the ODF process according to prior art and pure thermal process using the same sealant of Example 1. Even if the open time which was calculated from cell assembly completion to the placement of the cell in oven was as long as 4 min in closed dummy situation when the sealant line width was only about 0.5 mm, no significant LC penetration into the sealant could be inspected by microscope. However, significant LC leakage were observed with the sample manufactured by prior art ODF process and pure thermal curing process with using the same sealant composition.

The samples manufactured by the inventive process with the sealant of Example 1 also showed good compatibility with LC as no significant LC misalignment was found, while slightly misalignment was observed around sealant by prior art process and severe misalignment was inspected when the sealant was heated directly after cell assembly without any exposure to UV light.

From the above test results, it can be seen that the arrangement of UV curing process before dropping LC could greatly improve the resistance to LC penetration and compatibility with LC due the sealant composition was partially cured after the first UV curing step, and appropriate viscosity and modulus were obtained to withstand penetration from LC, and complete cell assembly to achieve a targeted cell gap. The inventive process with combining UV curing and thermal curing could also reduce contamination from compositions to LC as most of the small molecular components have been crosslinked after the UV curing step and subsequently had less opportunity to move out and contact LC, which enables to seal liquid crystal by one-drop-filling method.

TABLE 3
The conditions of the inventive ODF process for cell quality

| | Example | | |
|---|---|---|---|
| Items | 1 | 2 | 3 |
| UV radiation | 500 mJ/cm² | 1000 mJ/cm² | 1000 mJ/cm² |
| energy | | | |
| Thermal curing | 120° C. for | 120° C. for | 120° C. for |
| condition | 1 hour | 1 hour | 1 hour |

Examples 1 to 3 were used to produce cells by the inventive ODF process according to the curing conditions as shown in Table 3. Cell quality including LC leakage and line widths were inspected under a microscope with a magnification of X100.

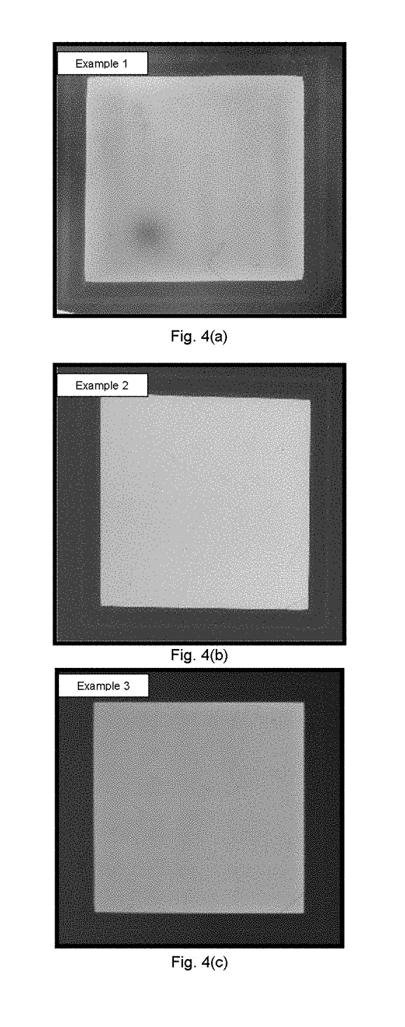

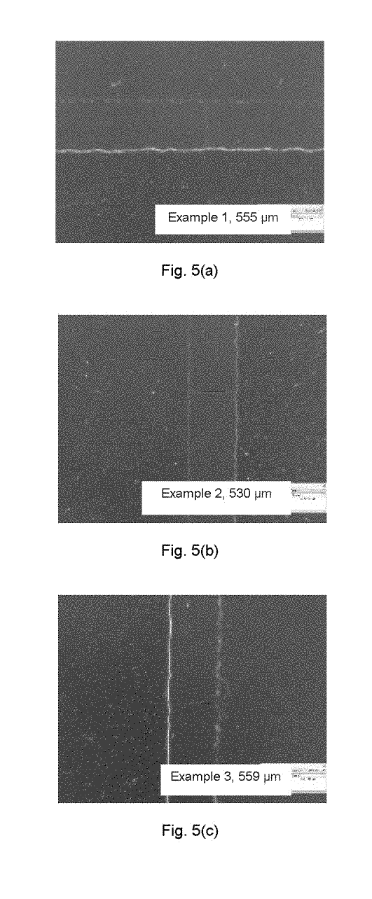

From the testing results shown in FIGS. 4(a) to 4(c) and 5(a) to 5(c), it is apparent that the inventive ODF process can be applied to all sealant compositions from Examples 1 to 3. As shown in FIGS. 4(a) to 4(c), no LC leakage and no gap issue were inspected in the samples. As shown in FIGS. 5(a) to 5(c), the targeted line widths were obtained respectively.

1. A process of producing a liquid crystal display having a liquid crystal layer between a first substrate and a second substrate, comprising steps of:
1) applying a curable resin composition on a sealing region at a periphery of a surface of the first substrate;
2) radiation curing the curable resin composition, and obtaining a partially cured product;
3) dropping liquid crystal on a central area encircled by the sealing region of the surface of the first substrate or the corresponding area of the second substrate, and forming the liquid crystal layer;
4) overlaying the second substrate on the first substrate; and
5) thermally curing the partially cured product.

2. The process of producing a liquid crystal display according to claim 1, wherein the curable resin composition comprises a radiation curable resin, a thermally curing agent and optionally an epoxy resin.

3. The process of producing a liquid crystal display according to claim 2, wherein the radiation curable resin is present from 10% to 98%, preferably from 30% to 95%, by weight of the curable resin composition.

4. The process of producing a liquid crystal display according to claim 2 or 3, wherein the thermally curing agent is present from 0.1% to 40%, preferably from 0.5% to 30%, by weight of the curable resin composition.

5. The process of producing a liquid crystal display according to any of claims 2 to 4, wherein if present, the epoxy resin is present from 1% to 60%, preferably from 10% to 50%, by weight of the curable resin composition.

6. The process of producing a liquid crystal display according to any of claims 1 to 5, wherein the radiation wavelength of the radiation curing is from 200 nm to 450 nm, preferably from 300 nm to 450 nm.

7. The process of producing a liquid crystal display according to any of claims 1 to 6, wherein the radiation energy of the radiation curing is from 100 to 10,000 mJ/cm², preferably from 100 to 5,000 mJ/cm².

8. The process of producing a liquid crystal display according to any of claims 1 to 7, wherein the modulus of the partially cured product measured at 25° C. is from 100 to 100,000 Pa, preferably from 500 to 50,000 Pa, more preferably from 1,000 to 20,000 Pa.

9. The process of producing a liquid crystal display according to any of claims 1 to 8, wherein the curing temperature of the thermal curing is from 70° C. to 150° C., preferably from 100° C. to 130° C.

10. The process of producing a liquid crystal display according to any of claims 1 to 9, wherein the duration of the thermal curing is from 0.5 hour to 3 hours, preferably from 1 hour to 2 hours.

11. The process of producing a liquid crystal display according to any of claims 1 to 10, wherein the process further comprising a step of further radiation curing the partially cured product between steps 4) and 5).

12. A curable resin composition used for the process of producing a liquid crystal display according to any of claims 1 to 11.

13. A liquid crystal display manufactured by the process of producing a liquid crystal display according to any of claims 1 to 11.
